(19) United States
(12) Patent Application Publication
(10) Pub. No.: US 2010/0046077 A1
(43) Pub. Date: Feb. 25, 2010

(54) WAVELENGTH SELECTIVE METALLIC EMBOSSING NANOSTRUCTURE

(75) Inventors: Byounghee Lee, Wexford, PA (US); Byung Il Choi, Pittsburgh, PA (US)

Correspondence Address: FOLEY AND LARDNER LLP;SUITE 500, 3000 K STREET NW, WASHINGTON, DC, 20007, US

(73) Assignee: NanoLambda Inc.

(21) Appl. No.: 12/521,376

(22) PCT Filed: Dec. 21, 2007
(86) PCT No.: PCT/US07/26135

§ 371 Date: Jun. 26, 2009

Related U.S. Application Data
(60) Provisional application No. 60/877,660, filed on Dec. 29, 2006.

(51) Int. Cl. G02B 5/20; G02B 1/10

(52) U.S. Cl. 359/585; 977/700

(57) ABSTRACT

In accordance with embodiments of the present invention, a nano structure optical wavelength filter is provided. A film made of a negative dielectric constant material such as a metal has embossing structures of subwavelength scale, located thereon in an array in a pattern. The array pattern and the structures are configured such that when light is incident on the array structures, at least one plasmon mode is resonant with the incident light to produce a transmission spectral window with desired spectral profile, bandwidth and beam shape.

### CROSS-REFERENCE TO RELATED PATENT APPLICATIONS

The present application claims benefit of U.S. provisional application 60/877,660, filed Dec. 29, 2006, which is incorporated herein by reference in its entirety.

### BACKGROUND OF THE INVENTION

Optical filtering is an important concept in optics, and is commonly involved in a variety of optical components and instruments. One example is to use optical filters for optical detectors. Optical detectors are normally sensitive to a broad spectrum of light so that light of broad range of lights all might be detected. Therefore it would be much more useful to have a material or a device that operates exactly in a reverse manner that it selectively transmits light only in a narrow range of frequencies within a broad spectrum.

Filters made from wire-mesh or metallic grids have been used extensively for filtering light in the far IR (infrared) spectrum. Such filters and devices incorporating the filters are disclosed in U.S. application Ser. Nos. 10/566,946 and 11/345,673 filed on Jul. 22, 2004 and 2/206, respectively, both of which are incorporated herein by reference in their entirety. These filters comprise thin metallic wires (much thinner than the wavelengths to be transmitted) deposited on an optically transparent substrate. The filters are characterized by a transmission spectrum having a peak at approximately 1.2 times the periodicity of the mesh. The peak is very broad, typically greater than half of the periodicity of the mesh. These filters would be much more useful if their transmission spectra could be narrowed to make them more selective.

### SUMMARY OF THE INVENTION

A film made of a negative dielectric constant material such as a metal has embossing structures of subwavelength scale, located thereon in an array in a pattern. The array pattern and the structures are configured such that when light is incident on the array structures, at least one plasmon mode is resonant with the incident light to produce a transmission spectral window with desired spectral profile, bandwidth and beam shape. Such embossing structures can be used as various wavelength filtering devices for chip scale spectrometer, color image sensor, hyperspectral image sensor or color flat panel display, and for beam shaping devices.

### BRIEF DESCRIPTION OF THE DRAWINGS

FIG. 1 is a perspective view of an embossing array on a metallic film;

FIG. 2 is a cross sectional view of an embossing array on a metallic film shown in FIG. 1;

FIGS. 3A and 3B are graphical representations of transmission intensity as a function of wavelength for different embossing array geometries;

FIGS. 4A through 4K show perspective views of examples of different embossing structures;

FIGS. 5A, 5B, 5C and 5D show examples of different plan view layouts of embossing structures;

FIG. 6A is schematic representation of a monochromator;

FIG. 6B is schematic representation of a chip scale spectrometer;

FIG. 6C is schematic representation of a multispectral image sensor.

### DETAILED DESCRIPTION OF THE PREFERRED EMBODIMENTS

Unless otherwise specified, the words “a” or “an” as used herein mean “one or more”. The term “light” includes visible light as well as UV and IR radiation. The invention includes the following embodiments.

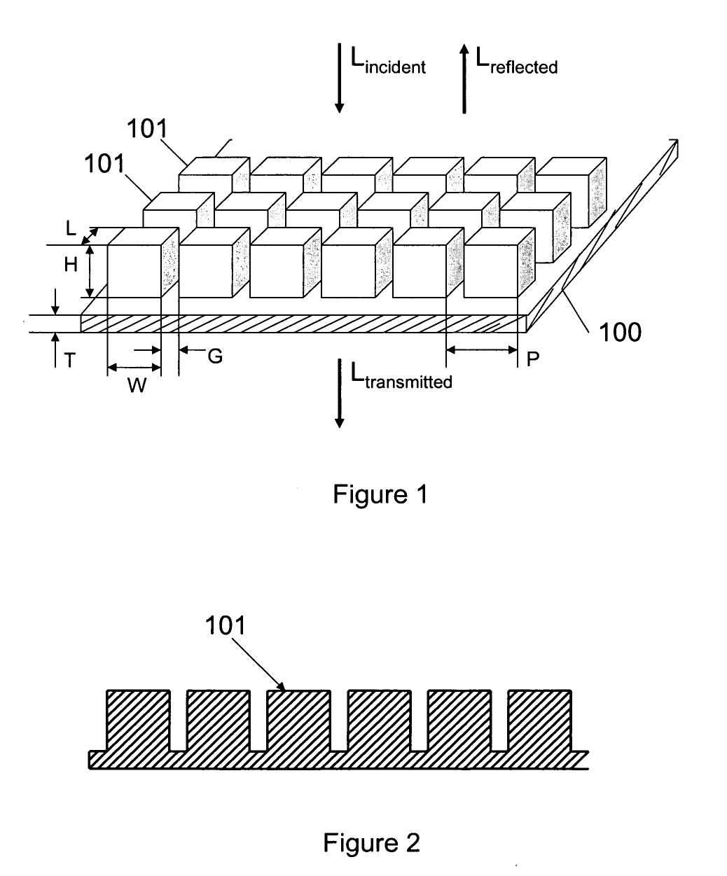

In FIG. 1, a thin metallic film 100 containing an array of embossing structures 101, such as metal structures 101, in a square pattern, is shown (not to scale). The metal may be any metal and is preferably Ag, Au, Cr or Al or alloys thereof. The gap between embossing structures is G. The width, length and height of the embossing structures are W, L and H respectively. The thickness of metallic film or plate 100 is preferably in the range of approximately 1 to 50 nm which is partially optically transparent. The intensity of the incident light is L_{incident} and the intensity of the transmitted light after traveling through the gaps in the embossing structures and film is L_{transmitted}. In FIG. 1 an unsupported thin metal plate is shown, however, a thin metal film deposited on an optically transparent substrate, such as a glass, quartz or polymer, is also contemplated by the present invention. Thus, the metal film 100 is continuous and does not need to contain any openings or holes which extend through the entire film in the gap region. Thus, the film 100 is preferably continuous and contains no through openings in the gap or the feature 101 regions. In contrast, prior art plasmonic resonance structures contain through holes which extend through the entire metal film.

The embossing structures 101 may be formed by any suitable method. For example, the structures 101 may be formed by embossing grooves into the film to form the gaps G. Alternatively, the structures may be formed by photolithographic etching of the gaps G in the film. Alternatively, the structures 101 may be formed by direct deposition of the structures 101 on the metal film 100 or by forming a metal layer on the film 100 and patterning the layer into the structures 101. Alternatively, the structures 101 may be formed by electroplating or electroless plating. Alternatively, the structures 101 may be formed by combination of aforementioned methods.

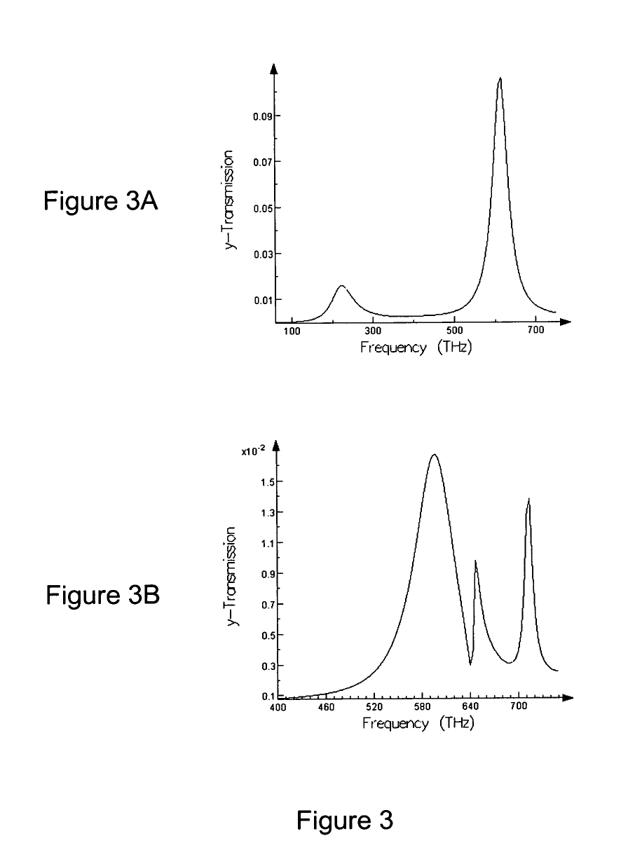

The arrays of embossing structures shown in FIG. 1, exhibit distinct transmission spectra with well defined peaks. The power level of transmitted light is much greater than the expected power level from conventional theory. FIG. 3 shows FDTD simulations which indicate that the unusual optical properties are probably due to the resonance of the incident light with the surface plasmons of the embossing structure array in metal. It is possible that other phenomena, such as interference due to array geometry, also contributes to the wavelength selective enhanced transmission.

In FIG. 3, the solid line represents transmission of light through a 30 nm thick Ag film, having embossing feature 101 height of 200 nm and a 40 nm gap G between features 101. For the simulation shown in FIG. 3A, the embossing width is 200 nm and embossing length is 200 nm. For the simulation shown in FIG. 3B, the embossing feature width and length are both 400 nm. The peaks occur in relation to the thickness of embossing, gap between embossing and period of the array. The bandwidth of the peaks is also strongly dependent on the gap between embossing and period of array.

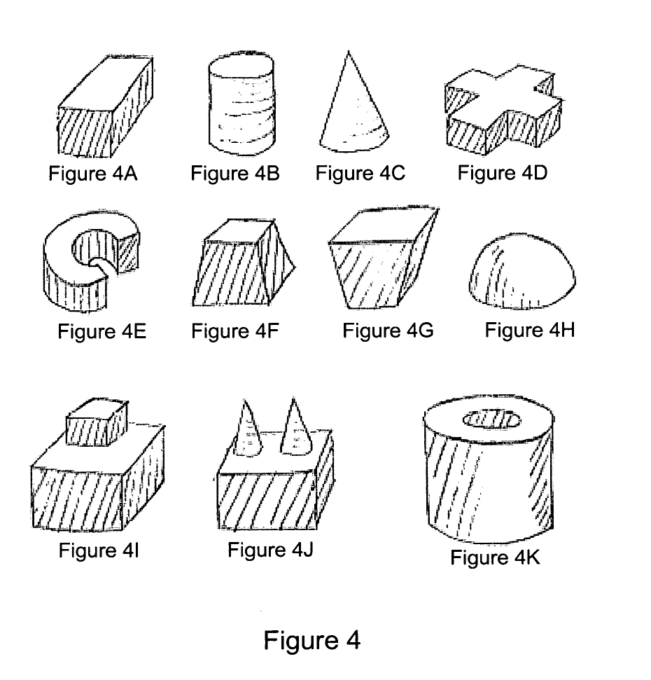

The structures do not have to have rectangular shapes. For example, various other shapes shown in FIGS. 4A through 4K show perspective views of examples of different embossing structures which can be used to provide the plasmonic coupling effect between the film 100 and the incident radiation.

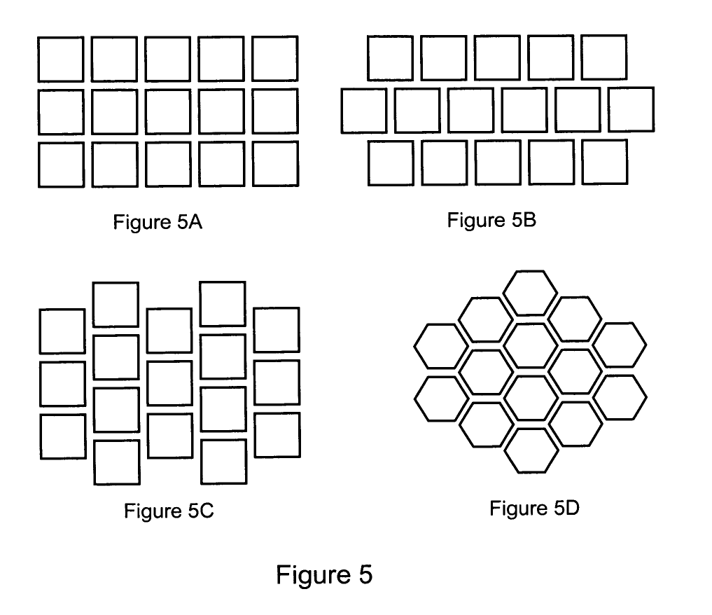

FIGS. 5A, 5B, 5C and 5D show examples of different plan view layouts of embossing structures. Thus, the structures 101 may be laid out in a square grid as shown in FIG. 5A or they may be offset from the square grid along the width or length directions, as shown in FIGS. 5B, 5C and 5D. Furthermore, the structures 101 may comprise non-rectangular structures, such as hexagonal structures which are arranged in a honeycomb pattern, as shown in FIG. 5D.

### Applications

The novel optical filtering functions that have been revealed and demonstrated with subwavelength scale array of metallic embossing structures proposed here are expected to bring a major impact on various fields that involves optics.

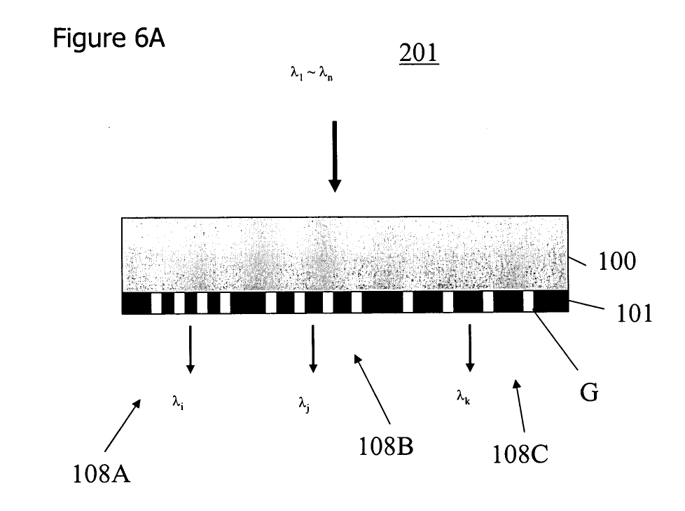

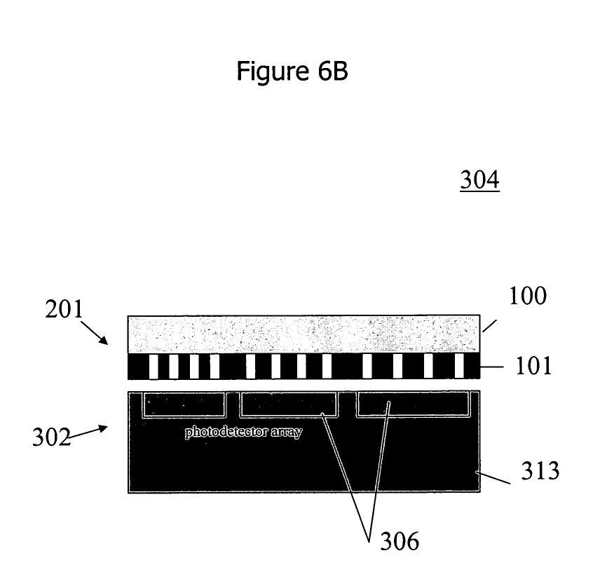

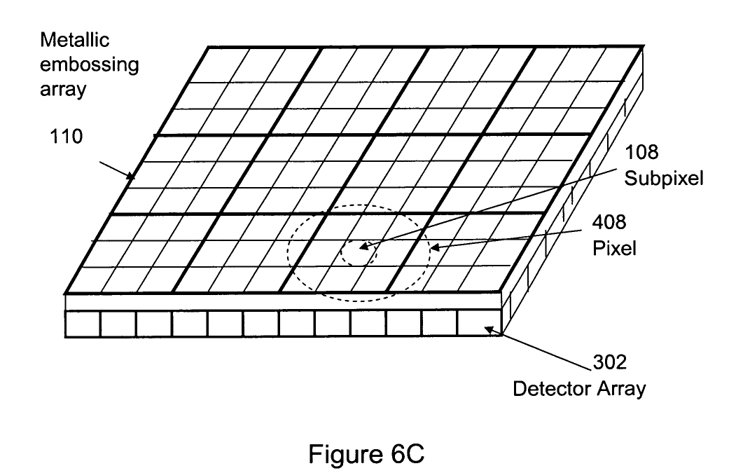

FIG. 6A is schematic illustration of wavelength separation using the embossed film as a micron-scale monochromator device 201. As shown in FIG. 6A, incident radiation having a range of wavelengths λ₁ to λₙ is provided onto the metal film 100 having the plurality of features 101. The transmitted radiation is provided through the plurality of gaps between the features such that the transmitted radiation is simultaneously separated into a plurality of passbands having different peak wavelengths λᵢ, λⱼ, and λₖ. The incident radiation may be provided onto either side of the film 101.

The metal film 101 is divided into a desired number of cells or regions 108, such as at least two cells, where the size of the features 101 and gaps G is substantially the same within each cell. However, the size of the features 101 and/or gaps G and/or a period between the gaps G differs between cells. For example, three cells 108A, 108B and 108C are illustrated in FIG. 1.

The configuration of the features 101 and gaps G in each cell 108 is designed to produce a passband at a certain peak wavelength in the transmission spectrum. Thus, a transmission of the radiation having one peak wavelength is enhanced due to the geometry in the first cell 108A. A transmission of the radiation having a different peak wavelength is enhanced due to the different geometry in the second cell 108B.

Preferably, the device 201 contains at least ten cells, more preferably at least 30 cells, such as 30 to 3,000 cells, for example 30 to 1,000 cells. Preferably, the passband radiation transmitted through each cell 108 has a peak wavelength that differs by at least 1 nm, such as by at least 10 nm, for example by 10 to 100 nm, from peak wavelengths of radiation transmitted through the other cells 108.

The wavelength separation device 201 can be used together with a photodetector 302 to form a spectrum analyzer or spectrometer 304, as shown in FIG. 6B. Any device which can detect visible, UV and/or IR passband transmitted radiation may be used as the photodetector 302. The photodetector 302 is adapted to detect radiation transmitted through the wavelength separation device 201. Preferably, an array of solid state photodetector cells, such as a semiconductor photodetector array is used as a photodetector. Most preferably, charge coupled devices (CCDs), a CMOS active pixel sensor array or a focal plane array are used as the photodetector. The photodetector 302 shown in FIG. 6B includes a substrate 313, such as a semiconductor or other suitable substrate, and a plurality of photosensing pixels or cells 306. Preferably, each photodetector cell or pixel 306 is configured to detect passband radiation having a given peak wavelength from each respective cell 108 of the wavelength separation device 201.

FIG. 6C is schematic representation of a multispectral imaging system, when the monochromator is extended to a two dimensional array configurations. A multispectral imaging system is a system which can form an image made up of multiple colors. One example of a multispectral imaging system is a digital color camera which can capture moving and/or still color digital images of objects or surroundings. Another example of a multispectral imaging system is an infrared camera, which forms a digital image in visible colors of objects emitting infrared radiation, such as a night vision camera. The camera contains a processor, such as a computer, a special purpose microprocessor or a logic circuit which forms a color image (i.e., as data which can be converted to visually observable image or as an actual visually observable image) based on radiation detected by the photodetector. The multispectral imaging system may store the color image in digital form (i.e., as data on a computer readable medium, such as a computer memory or CD/DVD ROM), in digital display form (i.e., as a still or moving picture on a screen) and/or as a printout on a visually observable tangible medium, such as a color photograph on paper.

FIG. 6C shows a multispectral imaging system comprising a three dimensional wavelength separation device (i.e., the metallic embossing array) 110 and a photodetector 302. The system contains an array of cells or pixels 408 arranged in two dimensions in the wavelength separation device 201. Preferably, the cells 408 are arranged in a rectangular or square matrix layout. However, any other layout may be used instead. Each cell 408 is adapted to produce a multicolor portion of a multidimensional image.

Each cell or pixel 408 comprises at least three subcells or subpixels 108 shown in FIG. 6A, such as nine subpixels. Each subcell 108 in a particular cell 408 is designed to transmit one particular color (or a narrow IR, VIS or UV radiation band). Each cell 418 of the array 110 is preferably identical to the other cells in the array because each cell contains the same arrangement of subcells 108.

The array 110 can also be used in a liquid crystal display as a color filter for each pixel of the LCD. In this case, the array 110 is positioned over a back light which emits white light and the array filters particular light colors for each pixel.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

1. An optical filter comprising:
a metal film; and
an array of embossings on said film;
wherein:
adjacent embossings in the array are spaced apart by a gap, where said gap width is less than at least one first predetermined wavelength of incident light on film;
said film has a thickness in the range where the said film is optically partially transparent; and
size and shape of embossings, and said gap are configured such that the incident light is resonant with at least one plasmon mode on the array of embossings in said metal film, and the predetermined wavelength will perturb the metallic embossings in surface plasmon energy bands for the wavelength selective transmission of light.

2. An optical filter as set forth in claim 1, wherein said film is located over an optically transparent substrate.

3. An optical filter as set forth in claim 1, wherein said array of embossing forms a pattern.

4. A spectrometer comprising the filter of claim 1.

5. A multispectral imaging device comprising the filter of claim 1.

6. A flat panel display device comprising the filter of claim 1.

7. An optical filter as set forth in claim 1, wherein the film contains no openings which extend through the film and the film is at least partially transparent in the gap regions to the incident radiation.

8. An optical filtering method comprising:
providing incident light onto an optical filter comprising a metal film and an array of embossings on said film, wherein adjacent embossings in the array are spaced apart by a gap, where said gap width is less than at least one first predetermined wavelength of incident light on film; and
transmitting the light through the at least partially transparent gap regions in the film, such that transmitted light is filtered;
wherein the incident light is resonant with at least one plasmon mode on the array of embossings in said metal film, and the predetermined wavelength of the incident light perturbs the metallic embossings in surface plasmon energy bands for a wavelength selective transmission of light.

9. A nanoplasmonic optical filter in which incident light is resonant with at least one plasmon mode of the filter, comprising:
a continuous metal film; and
an array of embossings on said film;
wherein:
adjacent embossings in the array are spaced apart by a gap; and
the metal film below each gap is at least partially transparent to incident light and contains no through opening.

10. An optical filtering method, comprising:
passing incident light through a nanoplasmonic optical filter such that the incident light is resonant with at least one plasmon mode of the filter for a wavelength selective transmission of the incident light;
wherein the filter comprises:
a continuous metal film; and
an array of embossings on said film, wherein adjacent embossings in the array are spaced apart by a gap, and the metal film below each gap contains no through opening and the metal film below each gap is at least partially transparent to incident light such that the light passes through the film in the gap region.
